(19) United States
(12) Patent Application Publication
(10) Pub. No.: US 2026/0093644 A1
(43) Pub. Date: Apr. 2, 2026

(54) REMOTE DIRECT MEMORY ACCESS BASED IMPLEMENTATION OF THE LOGICAL EXECUTION TIME PARADIGM

(71) Applicant: GM Global Technology Operations LLC, Detroit, MI (US)

(72) Inventors: Markus Jochim, Troy, MI (US); Yuchen Zhou, Rochester Hills, MI (US); Khaja Shazzad, Windsor (CA)

(73) Assignee: GM Global Technology Operations LLC, Detroit, MI (US)

(21) Appl. No.: 18/901,810

(22) Filed: Sep. 30, 2024

(51) Int. Cl. G06F 13/16; G06F 13/28

(52) U.S. Cl. CPC G06F 13/1673; G06F 13/28

(57) ABSTRACT

A system and method include copying data from a first memory buffer of a first device to a second memory buffer of the first device, the data written to the first memory buffer during a first task, receiving a periodic work request, and reading the data from the second memory buffer. The system and method also include transmitting the data to a second device in communication with the first device, writing the transmitted data into a third memory buffer of the second device, the transmitted data needed to complete a second task, and before a logical execution time (LET) of the second task begins, copying the data from the third memory buffer of the second device to a fourth memory buffer of the second device.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a remote direct memory access (RDMA) based implementation of the logical time execution (LET) paradigm. In particular, vehicles may have multiple nodes within a system (e.g., different ECUs in a vehicle) that are connected by a communication system (e.g., ethernet). However, application tasks interacting with other application tasks on the same or other nodes traditionally need to know where the other application tasks are located to interact with the other application tasks. As such, when an application moves from its original setting, the code of the application task must be updated to continue interacting with other application tasks. This applies in cases where interacting applications were previously located on the same node (e.g., ECU) and are moved to different ECUs, as well as in the reverse case, where applications were previously located on different ECUs and are moved to the same ECU. Moreover, relying on the application tasks to manage communications with the RDMA mechanism may be computationally burdensome and introduce latency within the system.

### SUMMARY

One aspect of the disclosure provides a computer-implemented method for a remote direct memory access (RDMA) based implementation of the logical execution time (LET) paradigm that when executed on data processing hardware causes the data processing hardware to perform operations that include copying data from a first memory buffer of a first device to a second memory buffer of the first device, the data written to the first memory buffer during a first task, receiving a periodic work request, and reading the data from the second memory buffer. The operations also include transmitting the data to a second device in communication with the first device and writing the transmitted data into a third memory buffer of the second device, the transmitted data needed to complete a second task. Before a logical execution time (LET) of the second task begins, the operations further include copying the data from the third memory buffer of the second device to a fourth memory buffer of the second device.

Implementations of the disclosure may include one or more of the following optional features. In some implementations, the periodic work request includes one or more of a read request or a write request. In some examples, the periodic work request is scheduled during a configuration phase of a vehicle. In some implementations, the first device and the second device are time synchronized. In some examples, copying the data from the first memory buffer of the first device to the second memory buffer of the first device occurs when a LET of the first task ends. In some implementations, copying the data from the first memory buffer of the first device to the second memory buffer of the first device includes preempting any application tasks running on the first device.

In some examples, transmitting the data to the second device in communication with the first device occurs for a time bounded duration. In some implementations, the second device is in communication with the first device via an in-vehicle communication system of a vehicle. In some examples, copying the data from the first memory buffer of the first device to the second memory buffer of the first device is executed by an operating system of the first device. In some implementations, the periodic work request is initiated by a remote direct memory access (RDMA) communication controller of the first device.

Another aspect of the disclosure provides a system using an RDMA based implementation of the LET paradigm that includes data processing hardware and memory hardware in communication with the data processing hardware. The memory hardware stores instructions that when executed by the data processing hardware cause the data processing hardware to perform operations that include copying data from a first memory buffer of a first device to a second memory buffer of the first device, the data written to the first memory buffer during a first task, receiving a periodic work request, and reading the data from the second memory buffer. The operations also include transmitting the data to a second device in communication with the first device and writing the transmitted data into a third memory buffer of the second device, the transmitted data needed to complete a second task. Before a logical execution time (LET) of the second task begins, the operations further include copying the data from the third memory buffer of the second device to a fourth memory buffer of the second device.

This aspect may include one or more of the following optional features. In some implementations, the periodic work request includes one or more of a read request or a write request. In some examples, the periodic work request is scheduled during a configuration phase of a vehicle. In some implementations, the first device and the second device are time synchronized. In some examples, copying the data from the first memory buffer of the first device to the second memory buffer of the first device occurs when a LET of the first task ends. In some implementations, copying the data from the first memory buffer of the first device to the second memory buffer of the first device includes preempting any application tasks running on the first device.

In some examples, transmitting the data to the second device in communication with the first device occurs for a time bounded duration. In some examples, copying the data from the first memory buffer of the first device to the second memory buffer of the first device is executed by an operating system of the first device. In some implementations, the periodic work request is initiated by a remote direct memory access (RDMA) communication controller of the first device.

Another aspect of the disclosure provides a computer-implemented method of periodically scheduling an RDMA based implementation of the LET paradigm that when executed on data processing hardware causes the data processing hardware to perform operations that include, during a configuration phase of a vehicle, scheduling a periodic work request for a remote direct memory access (RDMA) communication controller of a first device of the vehicle. Here, the periodic work request causes the RDMA controller to automatically create a work request to transmit data between the first device and a second device in communication with the first device, the work request based on parameters of the periodic work request.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system using a remote direct memory access (RDMA) based implementation of the logical execution time paradigm (LET).

FIG. 2 is a schematic view of example components of the system of FIG. 1.

FIG. 3 is a schematic of the view of the LET input/output requirements of a task of the system of FIG. 1.

FIG. 4 is a timeline view of example components of the system of FIG. 1.

FIG. 5 is a flowchart of an example arrangement of operations for a method for an RDMA based implementation of the LET paradigm.

FIG. 6 is a flowchart of an example arrangement of operations for a method of periodically scheduling an RDMA based implementation of the LET paradigm.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

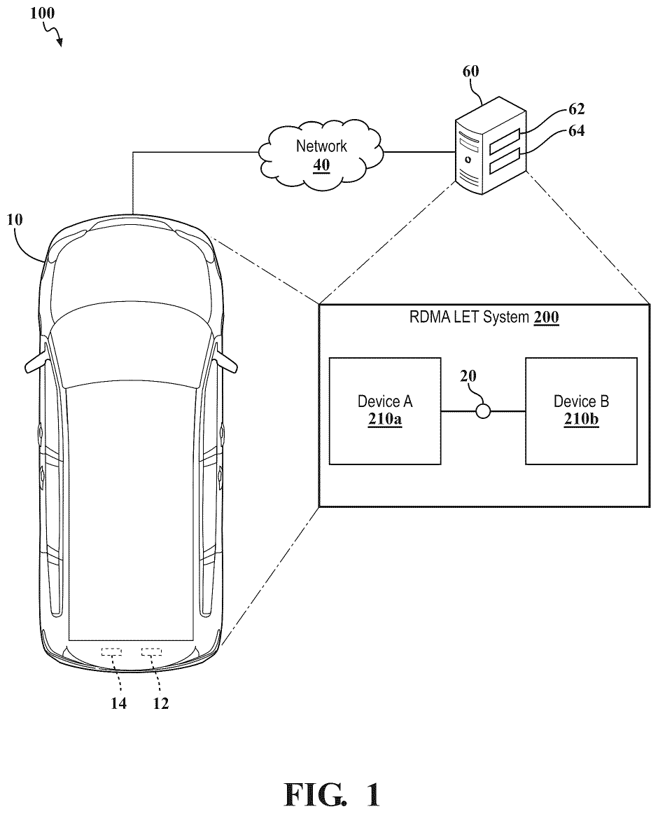

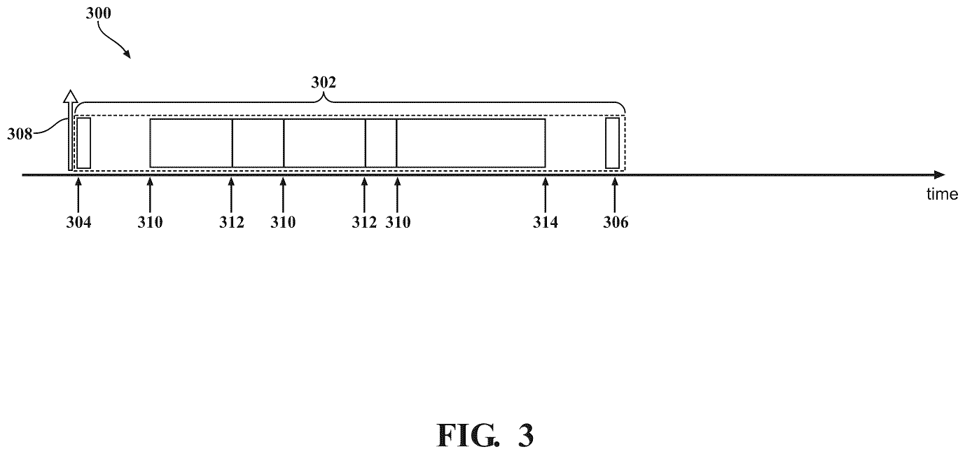

Referring to FIG. 1, in some implementations, a system 100 includes a vehicle 10 and/or a remote system 60 in communication with the vehicle 10 via a network 40 (e.g., wired or wireless communication). The vehicle 10 and/or the remote system 60 execute a remote direct memory access (RDMA) based logical execution time (LET) system 200 configured to periodically post periodic work requests 230 to execute remote read and/or write operations (i.e., tasks) 300 (FIG. 3) and transmit data 202 generated by the tasks 300, thereby enforcing a logical execution time (LET) paradigm that guarantees time determinism and data flow determinism within the vehicle 10. As described with greater detail below, rather than relying on a vehicle application to periodically post read or write requests, the RDMA LET system 200 includes an RDMA engine 218 that automatically creates the periodic work requests 230, thereby decreasing the latency of the RDMA LET system 200. In contrast, in state-of-the-art RDMA systems, in order for work requests 240 to occur periodically, the application tasks are responsible for submitting work requests on a periodic basis, which is computationally burdensome for the vehicle applications. Moreover, by abstracting away communication related tasks from the vehicle applications, the application code does not need to be updated for the RDMA LET system 200 if a vehicle application moves within the vehicle 10.

In the example shown, the RDMA LET system 200 is implemented within the vehicle 10. However, the RDMA LET system 200 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 12 to perform operations. The remote system 60 (e.g., server, cloud computing environment) also includes data processing hardware 62 and memory hardware 64 storing instructions that when executed on the data processing hardware 62 cause the data processing hardware 62 to perform operations. In some implementations, execution of the RDMA LET system 200 is shared across the vehicle 10 and/or the remote system 60.

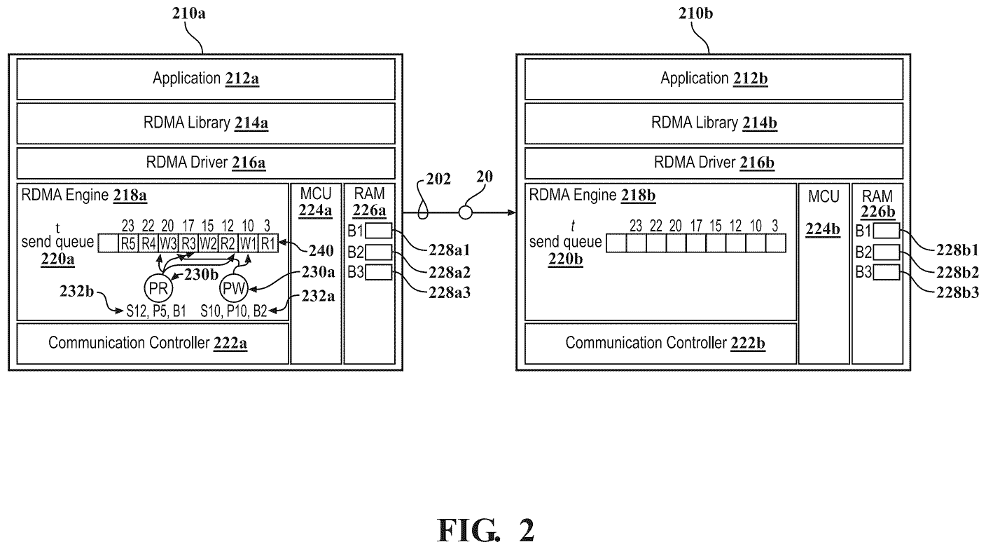

Referring to FIGS. 1 and 2, the RDMA LET system 200 may include two or more devices 210 each in communication with one another via an in-vehicle communication system 20 of the vehicle 10. For instance, the in-vehicle communication system 20 may include an ethernet based network. In other implementations, the in-vehicle communication system 20 may include InfiniBand networks. As shown, the two or more devices 210 include a first device 210a (also referred to as device A 210a) and a second device 210b (also referred to as device B 210b) in communication with one another via the in-vehicle communication system 20 of the vehicle 10. However, it should be appreciated that the RDMA LET system 200 may include any number of interconnected devices 210. Each of the devices 210 of the RDMA LET system 200 are time synchronized and have a common notion of time. For example, the devices 210 may be synchronized using time synchronization protocols such as IEEE 802.1AS.

Each device 210 of the RDMA LET system 200 may form part of the data processing hardware 12, 62 and memory 14, 64 of FIG. 1 and may include an RDMA capable device (also referred to as an RDMA electronic control unit (ECU)). In other implementations, each of the devices 210 in the RDMA LET system 200 may include an RDMA capable smart sensor, or an RDMA capable smart actuator. Each device 210 may include application software 212, RDMA library software 214, RDMA driver software 216, an RDMA engine 218, a communication controller 222, a microcontroller (MCU) 224, and memory 226. The RDMA engine 218 may include a send queue 220 including work requests 240 for the RDMA engine 218 to process. In some implementations, the work requests 240 include one or more of a read request or a write request. The memory 226 of each device 210 may additionally include one or more memory buffers 228. For example, the memory 226a of the first device 210a includes first memory buffer 228a₁, second memory buffer 228a₂, and third memory buffer 228a₃, while the memory 226b of the second device 210b includes first memory buffer 228b₁, second memory buffer 228b₂, and third memory buffer 228b₃. However, it should be appreciated that the respective memories 226a, 226b of the devices 210a, 210b may have any number of memory buffers 228. In some examples, each of the devices 210a, 210b are located on the same electronic control unit (ECU) of the vehicle 10 where the respective memories 226a, 226b are shared. In other examples, the devices 210a, 210b are deployed on different ECUs of the vehicle 10 and only communicate via the in-vehicle communication system 20.

With particular reference to FIG. 2, a work request 240 “R1” posted by the application software 212a is shown at time t3. The RDMA engine 218a may continuously process work requests 240 that are at the front of the send queue 220a and remove work requests 240 from the send queue 220a after they are processed/completed. For example, the work request 240 “R1” may contain a reference to a memory buffer 228b₁ of a second device 210b. Here, the RDMA engine 218a may task the communication controller 222a to send work requests associated with the memory buffer 228b₁ to the second device 210b using a transport protocol established between the communication controllers 222a, 222b of the devices 210a, 210b. The communication controller 222b receives the work request 240 “R1” from the communication controller 222a and forwards the work request 240 “R1” to the RDMA engine 218b. Thereafter, the RDMA engine 218b may identify that the work request 240 “R1” is associated with the memory buffer 228b₁ and use Direct Memory Access (DMA) to read the content of the memory buffer 228b₁ from the memory 226b. The RDMA engine 218b may then task the communication controller 222b with sending a read response to the work request 240 “R1” to the communication controller 222a, which contains the content of the memory buffer 228b₁, where the RDMA engine 218a identifies that the read response is in reference to the memory buffer 228b₁ and copies the read response into the corresponding memory buffer 228a₁ of the first device 210a. It should be understood that work requests 240 for writing data and reading data are processed the same.

Generally, state-of-the-art RDMA implementations rely on the application software 212 to periodically post these work requests 240 via the RDMA chain (i.e., work requests 240 via the RDMA library 214 and the RDMA driver 216) and perform RDMA communication with the RDMA engine 218 such as checking the RDMA completion queues and identifying communication errors. As opposed to state-of-the-art RDMA implementations that use the application software 212 to post work requests 240, which places a large communication processing burden on the application software 212 and may lead to latency within the RDMA implementation, the RDMA LET system 200 relies on the RDMA engine 218 to create periodic work requests 230 that are posted in the queue 220 alongside the other work requests 240 (i.e., work requests 240 created by the application software 212). In other words, the RDMA LET system 200 reassigns the role of the entity that posts/creates periodic work requests 230 from the application software 212 to the RDMA engine 218a to decrease latency within the RDMA LET system 200.

In some implementations, during a configuration phase of the vehicle 10, the RDMA LET system 200 is configured to schedule periodic work requests 232 for the RDMA communication controller 222. In particular, the periodic work request 232 may cause the RDMA communication controller 222 to automatically create a work request 232 to transmit data between the device 210 and another device 210 in the RDMA LET system 200. For example, as shown in FIG. 2, the RDMA communication controller 222a of the first device 210a may be configured to automatically post periodic work requests 230 process any work requests 240 in the send queue 220a. The periodic work requests 230 may include parameters 232. For instance, a first periodic work request 230a of the RDMA engine 218a may include parameters 232a that specify that the RDMA communication controller 222a is to, starting at time (t) ten (10), automatically post a write work request 240 that refers to the second memory buffer 228a₂ every ten (10) time units. Similarly, the RDMA engine 218a may be configured with a second periodic work request 232b that includes parameters 232b that specify that the RDMA communication controller 222a, starting at time twelve (12), automatically post a read work request 240 that refers to the first memory buffer 228a₁ every five (5) time units.

With continued reference to FIG. 2, the RDMA LET system 200 is shown at time t twenty-three (23) with a plurality of work requests 240 in the send queue 220a. The application software 212a of the first device 210a may have posted read requests 240 (i.e., R1, R5) at times three (3) and 23, and a write request 240 (i.e., W2) at time fifteen (15). Additionally, at time ten (10), the RDMA communication controller 222a automatically generates the first periodic work request 230a including the write work requests 240 (i.e. W1, W3) at times ten and twenty (20) and the second periodic work request 230b including the read work requests 240 (i.e., R2, R3, R4) at times twelve (12), seventeen (17), and 23. Thereafter, the RDMA engine 218a may execute the remote read and write operations associated with the work requests 240 in the order of the work requests 240 in the send queue 220a. For example, the RDMA engine 218a of the first device 210a may read data 202 from the memory 226a and transmit the data 202 over the in-vehicle communication network 20 to the second device 210b.

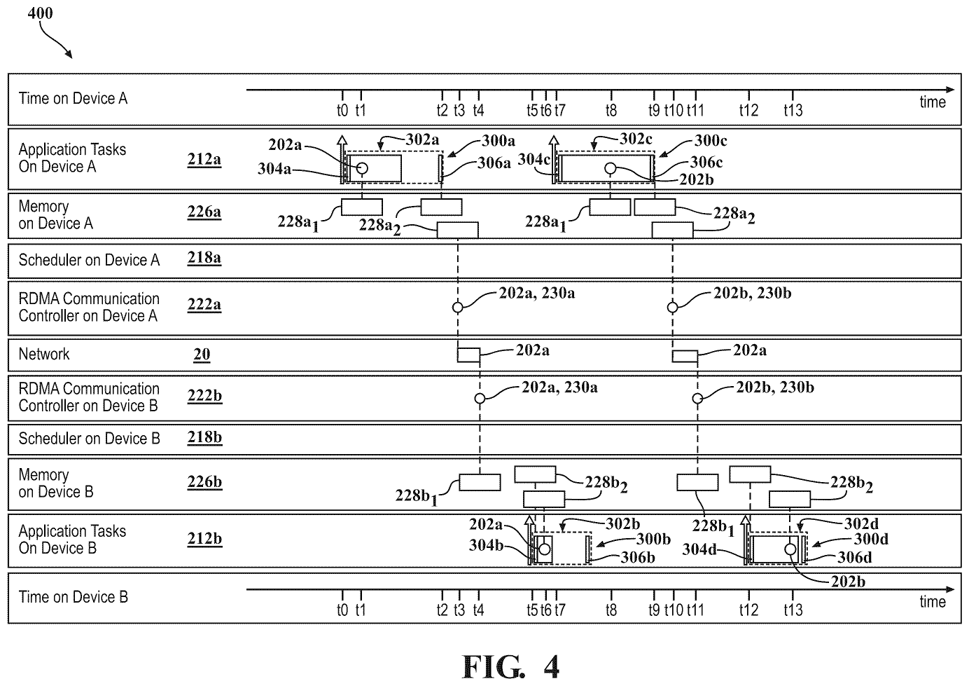

Referring to FIGS. 3 and 4, the RDMA LET system 200 may implement the periodic work requests 240 within the logical execution time (LET) and system level LET (SL-LET) paradigms. As is understood in the state-of-the-art, the LET and SL-LET paradigms have the benefit of time determinism and data flow determinism. For example, as shown in FIG. 3, a task 300 may be performed by the application software 212 of a device 210. As used herein, LET 302 generally refers to the time period long enough to accommodate the worst-case response time, including the maximum time required for reading task input values and writing task output values, of performing a task 300. Here, each task 300 may have an LET input/output requirement that requires that the input values for the application software 212 to complete the task 300 must be read at the start of the LET 302 (i.e., the activation 308 of the task 300), and the output values (i.e., data 202) generated by the task 300 must always be generated/written at the end of the LET 302. In other words, the LET input/output requirement of the LET 302 may include a start 304 of the task 300, and an end 306 of the task 300. As should be understood, the application 212 may not continually perform the task 300 during the LET 302. For instance, as shown, the application 212 may have one or more run times 310 where the application software 212 performs/processes the task 300, and one or more down times 312 where another task (e.g., a higher priority task) preempts the application software 212 from processing the task 300. As shown, the task 300 may actually terminate 314 at a time before the end 306 of the task 300 mandated by the LET input/output requirement of the LET 302. By enforcing the LET input/output requirement, the RDMA LET system 200 may achieve time determinism and data flow determinism.

Referring to FIG. 4, a timeline 400 of tasks 300a-300d and communication between a first device 210a (i.e., device A) and a second device 210b (i.e., device B) of the RMDA LET system 200 is shown. As noted above, the first device 210a and the second device 210b are time synchronized and have a common notion of time as shown by the timelines (i.e., time on Device A and time on Device B). Here, the RDMA LET system 200 leverages the periodic work requests 230 to ensure that the LET input/output requirements 302a-302d for each of the tasks 300a-300 are fulfilled. In the example shown, the output data 202 generated by the MCU 224a on the first device 210a performed during tasks 300a, 300c is needed by the MCU 224b to perform the tasks 300b, 300d. Notably, the input data 202 needed by the MCU 224b on the second device 210b to perform the tasks 300b, 300d needs to be received over the in-vehicle communication system 20 on or before the respective starts 302b, 302d of the LETs 302b, 302d of the tasks 300b, 300d.

At time t0, the RDMA engine 218a of the first device 210a activates and schedules a first task 300a for the MCU 224a to execute. At time t1, while the MCU 224a executes the first task 300a, it writes first data 202a to the first memory buffer 228a₁ of the first device 210a. As shown, at the end 306a of the LET 302a of the first task 300a (i.e., time t2), the scheduler of the RDMA engine 218a copies the first data 202a from the first memory buffer 228a₁ to a second memory buffer 228a₂ of the first device 210a. In some implementations, an operating system (OS) of the device 210a copies the first data 202a from the first memory buffer 228a₁ to the second memory buffer 228a₂ by preempting any other application tasks running on the first device 210a. Here, the OS of the device 210a may be generally aware of the common notion of time of the devices 210a, 210b, and is configured with the LETs 302 of all of the tasks 300 on the device 210a such that it is aware of when an end 306 of a LET 302 for a particular task 300 occurs. For instance, the OS of the device 210a is configured with timers that ensure that the OS is activated whenever an LET 302 has its end 306 and will copy the data 202a from the task 300a from the first memory buffer 228a₁ to the second memory buffer 228a₂. Notably, the first task 300a cannot perform the step of copying the first data 202a from the first memory buffer 228a₁ to the second memory buffer 228a₂ as the device 210a cannot guarantee that the first task 300a will still be executing at the end 306a of the LET 302a.

At time t3, the RDMA communication controller 222a may post a periodic write request 230a instructing the RDMA engine 218a to write the first data 202a from the second memory buffer 228a₂ of the first device 210a to the second device 210b. As part of the periodic write request 230a, the RDMA communication controller 222a instructs the RDMA engine 218a to transmit the first data 202a to the second device 210b via the in-vehicle communication system 20. Here, the duration of the transmission of the first data 202 may be time bounded and may complete at time t4. Time bounding may ensure that the RDMA communication controller 222b of the second device 210b receives and writes the first data 202a to a third memory buffer 228b₁ (i.e., the first memory buffer 228b₁ of the second device 210b) before the start 304b of the LET 302b of the second task 300b. The time bounded transmission may be guaranteed by traffic shaping, traffic prioritization, and/or traffic scheduling from the IEEE 802.1 Time Sensitive Networking protocol suite.

To comply with the LET input/output requirement of the LET 302b of the task 300b, at time t5, the first data 202a stored in the third memory buffer 228b₁ is copied into the fourth memory buffer 228b₂ by the OS of the second device 210b. Like the OS of the first device 210b, the OS of the second device may be generally aware of the common notion of time of the devices 210a, 210b, and is configured with the LETs 302 of all of the tasks 300 on the second device 210b such that it is aware of when an end 306 of a LET 302 for a particular task 300 occurs. For instance, the OS of the second device 210b is configured with timers that ensure that the OS is activated whenever an LET 302 has its end 306 and will copy the first data 202a from the task 300a from the third memory buffer 228b₁ into the fourth memory buffer 228b₂. Thereafter, the first data 202a may be used as input for the MCU 224b of the second device 210b to use to execute the second task 300b. Here, the OS of the second device 210b may preempt any other application tasks running on the second device 210b to perform the operation of copying the first data 202a from the third memory buffer 228b₁ to the fourth memory buffer 228b₂. Notably, the second task 300b cannot perform the copy operation as the start 304b of the LET 302b does not run until time t5, while the second device 210b receives the transmission of the first data 202a at time t4. As shown, when the first data 202a is required by the second task 300b, the second task 300b reads the first data 202a from the fourth memory buffer 228b₂.

As should be apparent, the respective application software 212a, 212b (i.e., via the MCUs 224a, 224b) of the devices 210a, 210b are only ever reading and/or writing the data 202 to/from the respective memory buffers 228a, 228b and, as such, the application software 212 may be easily relocated without requiring an update to the location of the application. In other words, all communication related tasks are abstracted away from the application software 212 such that the communication tasks are transparent to the tasks 300 performed by the MCUs 224. Advantageously, the periodic work requests 230 allow the devices 210 to communicate with one another without the need for the application software 212 to periodically create read/write work requests 240.

At time t7, the RDMA engine 218a of the first device 210a activates and schedules a third task 300c for the MCU 224a to execute. At time t8, while the MCU 224a executes the third task 300c, it writes second data 202b to the first memory buffer 228a₁ of the first device 210a. As shown, at the end 306c of the LET 302c of the fourth task 300c (i.e., time t9), the scheduler of the RDMA engine 218a copies the second data 202b from the first memory buffer 228a₁ to the second memory buffer 228a₂ of the first device 210a. In some implementations, the OS of the first device 210a copies the first data 202a from the first memory buffer 228a₁ to the second memory buffer 228a₂ by preempting any other application tasks running on the first device 210a. Notably, the fourth task 300c cannot perform the step of copying the first data 202a from the first memory buffer 228a₁ to the second memory buffer 228a₂ as the device 210a cannot guarantee that the fourth task 300c will still be executing at the end 306c of the LET 302c.

At time t10, the RDMA communication controller 222a may post a periodic write request 230b instructing the RDMA engine 218a to write the second data 202b from the second memory buffer 228a₂ of the first device 210a to the second device 210b. As part of the periodic write request 230b, the RDMA communication controller 222a instructs the RDMA engine 218a to transmit the second data 202b to the second device 210b via the in-vehicle communication system 20. Here, the duration of the transmission of the first data 202 may be time bounded and may complete at time t11. Time bounding may ensure that the RDMA communication controller 222b of the second device 210b receives and writes the second data 202b to the third memory buffer 228b₁ (i.e., the first memory buffer 228b1 of the second device 210b) before the start 304d of the LET 302d of the fourth task 300d.

At time t12, the second data 202b stored in the third memory buffer 228b₁ is copied into the fourth memory buffer 228b₂ by the OS of the second device 210b. Thereafter, the second data 202b may be used as input data for the application software 212b of the second device 210b to use to execute the fourth task 300d. Here, the OS of the second device 210b may preempt any other application tasks running on the second device 210b to perform the operation of copying the second data 202b from the third memory buffer 228b₁ to the fourth memory buffer 228b₂. Here, the fourth task 300d cannot perform the copy operation as the start 304d of the LET 302d does not run until time t12, while the second device 210d receives the transmission of the first data 202a at time t11. As shown, when the second data 202b is required by the fourth task 300d, the fourth task 300d reads the second data 202d from the fourth memory buffer 228b₂.

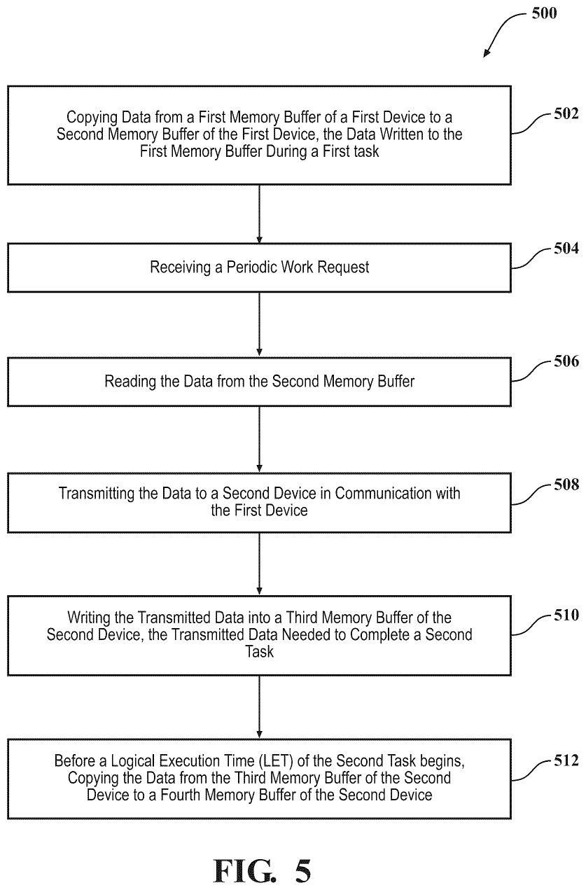

FIG. 5 includes a flowchart of an example arrangement of operations for a method 500 for preventing side door mishaps using existing TOF sensors. The method 500 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 500 At operation 502, the method 500 includes copying data 202 from a first memory buffer 228a₁ of a first device 210a to a second memory buffer 228a₂ of the first device 210a. Here, the data 202 is written to the first memory buffer 228a₁ during a first task 300a. The method 500 also includes, at operation 504, receiving a periodic work request 230. At operation 506, the method 500 also includes reading the data 202 from the second memory buffer 228a₂ of the first device 210a.

The method 500 further includes, at operation 508, transmitting the data 202 to a second device 210b in communication with the first device 210a. At operation 510, the method 500 also includes writing the transmitted data 202 into a third memory buffer 228b₁ of the second device 210b. Here, the transmitted data 202 is needed to complete a second task 300b. Before a logical execution time (LET) 302b of the second task 300b begins, the method 500 also includes, at operation 512, copying the data 202 from the third memory buffer 228b₁ to a fourth memory buffer 228b₂ of the second device 210b.

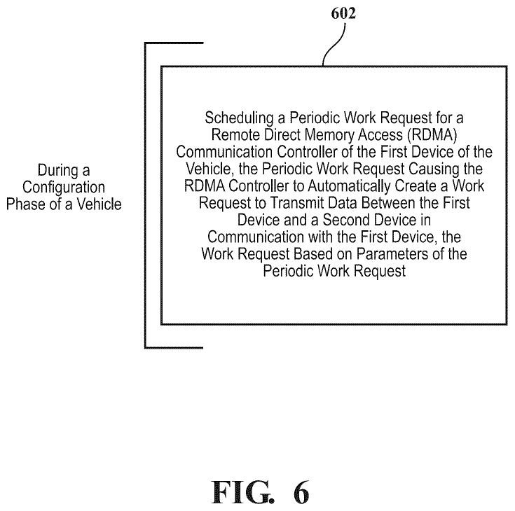

FIG. 6 includes a flowchart of an example arrangement of operations for a method 600 for preventing side door mishaps using existing TOF sensors. The method 600 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 600. During a configuration phase of a vehicle 10, the method 600 includes, at operation 602, scheduling a periodic work request 230 for a remote direct memory access (RDMA) communication controller 222a of a first device 210a. Here, the periodic work request 230 causes the RDMA communication controller 222a to automatically create a work request 230 to transmit data 202 between the first device 210a and a second device 210b in communication with the first device 210a, the work request 230 based on parameters 232 of the periodic work request 230.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
copying data from a first memory buffer of a first device to a second memory buffer of the first device, the data written to the first memory buffer during a first task;
receiving a periodic work request;
reading the data from the second memory buffer;
transmitting the data to a second device in communication with the first device;
writing the transmitted data into a third memory buffer of the second device, the transmitted data needed to complete a second task; and
before a logical execution time (LET) of the second task begins, copying the data from the third memory buffer of the second device to a fourth memory buffer of the second device.

2. The method of claim 1, wherein the periodic work request comprises one or more of a read request or a write request.

3. The method of claim 1, wherein the periodic work request is scheduled during a configuration phase of a vehicle.

4. The method of claim 1, wherein the first device and the second device are time synchronized.

5. The method of claim 1, wherein copying the data from the first memory buffer of the first device to the second memory buffer of the first device occurs when a LET of the first task ends.

6. The method of claim 1, wherein copying the data from the first memory buffer of the first device to the second memory buffer of the first device comprises preempting any application tasks running on the first device.

7. The method of claim 1, wherein transmitting the data to the second device in communication with the first device occurs for a time bounded duration.

8. The method of claim 1, wherein the second device is in communication with the first device via an in-vehicle communication system of a vehicle.

9. The method of claim 1, wherein copying the data from the first memory buffer of the first device to the second memory buffer of the first device is executed by an operating system of the first device.

10. The method of claim 1, wherein the periodic work request is initiated by a remote direct memory access (RDMA) communication controller of the first device.

11. A system comprising:
data processing hardware; and
memory hardware in communication with the data processing hardware, the memory hardware storing instructions that when executed on the data processing hardware cause the data processing hardware to perform operations comprising:
copying data from a first memory buffer of a first device to a second memory buffer of the first device, the data written to the first memory buffer during a first task;
receiving a periodic work request;
reading the data from the second memory buffer;
transmitting the data to a second device in communication with the first device;
writing the transmitted data into a third memory buffer of the second device, the transmitted data needed to complete a second task; and
before a logical execution time (LET) of the second task begins, copying the data from the third memory buffer of the second device to a fourth memory buffer of the second device.

12. The system of claim 11, wherein the periodic work request comprises one or more of a read request or a write request.

13. The system of claim 11, wherein the periodic work request is scheduled during a configuration phase of a vehicle.

14. The system of claim 11, wherein the first device and the second device are time synchronized.

15. The system of claim 11, wherein copying the data from the first memory buffer of the first device to the second memory buffer of the first device occurs when a LET of the first task ends.

16. The system of claim 11, wherein copying the data from the first memory buffer of the first device to the second memory buffer of the first device comprises preempting any application tasks running on the first device.

17. The system of claim 11, wherein transmitting the data to the second device in communication with the first device occurs for a time bounded duration.

18. The system of claim 11, wherein copying the data from the first memory buffer of the first device to the second memory buffer of the first device is executed by an operating system of the first device.

19. The system of claim 11, wherein the periodic work request is initiated by a remote direct memory access (RDMA) communication controller of the first device.

20. A computer-implemented method when executed on data processing hardware causes the data processing hardware to perform operations comprising:
during a configuration phase of a vehicle:
scheduling a periodic work request for a remote direct memory access (RDMA) communication controller of first device of the vehicle, the periodic work request causing the RDMA controller to automatically create a work request to transmit data between the first device and a second device in communication with the first device, the work request based on parameters of the periodic work request.
